(19) United States
(12) Patent Application Publication
(10) Pub. No.: US 2022/0404879 A1
(43) Pub. Date: Dec. 22, 2022

(54) SCREEN PROJECTION METHOD AND APPARATUS BASED ON WIRELESS AUXILIARY STREAM DEVICE

(71) Applicant: YEALINK (XIAMEN) NETWORK TECHNOLOGY CO., LTD., Xiamen (CN)

(72) Inventor: Hu Jiang, Xiamen (CN)

(21) Appl. No.: 17/842,821

(22) Filed: Jun. 17, 2022

(30) Foreign Application Priority Data
Jun. 18, 2021 (CN) 202110677507.0

(51) Int. Cl. G06F 1/16; G06F 3/01; G06F 3/14; G06F 3/0484; G06F 3/0487

(52) U.S. Cl. CPC G06F 1/1694; G06F 3/017; G06F 3/1454; G06F 3/0484; G06F 3/0487

(57) ABSTRACT

Disclosed are a screen projection method and apparatus based on a wireless auxiliary stream device. The method includes: displaying an interaction interface on the local display device when the terminal device is connected, where a plurality of triggerable function keys are disposed on the interaction interface, the plurality of function keys include program display keys corresponding to a plurality of programs and a screen display key, and the plurality of programs are programs currently running on the terminal device; obtaining, when a user triggers a target program display key corresponding to a target program, a target program image of the target program displayed on the local display device, and displaying the target program image by the extended display device; and displaying, by the extended display device, when the user triggers the screen display key, all images displayed on the local display device.

### CROSS-REFERENCE TO RELATED APPLICATIONS

The present application claims the benefit of Chinese Patent Application No. 202110677507.0 filed on Jun. 18, 2021, the contents of which are hereby incorporated by reference.

### TECHNICAL FIELD

The present application relates to the field of data processing technologies, and in particular, to a screen projection method and apparatus based on a wireless auxiliary stream device.

### BACKGROUND

With the development of data processing technologies, screen projection is used more frequently. For example, during a meeting, content in a computer is projected to a screen. Currently, a physical key is usually added to a wireless auxiliary stream device, the key is clicked to enter screen projection, and the key is clicked again to exit the screen projection. Therefore, an entire screen of a to-be-projected apparatus and all programs are projected to the screen, resulting in leakage of the privacy of a user to all participants. For example, when a user is making a PPT presentation, a chat tool receives a message, the message is also displayed on the screen, and the privacy of the user is made public.

### SUMMARY

Embodiments of the present application provide a screen projection method and apparatus based on a wireless auxiliary stream device, to resolve a problem that the privacy of a user may be leaked to all participants.

A screen projection method based on a wireless auxiliary stream device is provided, applicable to a wireless auxiliary stream device, where the wireless auxiliary stream device is connected to a terminal device and an extended display device, the terminal device is further connected to a local display device, and the method includes:

displaying an interaction interface on the local display device when the terminal device is connected, where a plurality of triggerable function keys are disposed on the interaction interface, the plurality of function keys include program display keys corresponding to a plurality of programs and a screen display key, and the plurality of programs are programs currently running on the terminal device;

obtaining, when a user triggers a target program display key corresponding to a target program, a target program image of the target program displayed on the local display device, and displaying the target program image by the extended display device; and

displaying, by the extended display device, when the user triggers the screen display key, all images displayed on the local display device.

Optionally, the obtaining a target program image of the target program displayed on the local display device, and displaying the target program image by the extended display device includes:

obtaining all the images displayed on the local display device;

recognizing a plurality of outer frame coordinates of the target program on all the images;

copying the target program image from all the images according to the plurality of outer frame coordinates; and

displaying the target program image by the extended display device.

Optionally, a size of an image that is capable of being displayed on the extended display device is the same as a size of an image that is capable of being displayed on the local display device, and a coordinate axis established by the extended display device is the same as a coordinate axis established by the local display device; and the displaying the target program image by the extended display device includes:

displaying the target program image at a target position on the extended display device according to the plurality of outer frame coordinates.

Optionally, the plurality of programs include the target program and non-target programs located on an upper layer of the target program; and the obtaining a target program image of the target program displayed on the local display device, and displaying the target program image by the extended display device includes:

recognizing overlapping parts between the target program image and images of the non-target programs;

covering an overlapping part on the target program image with black, and generating a covered target program image; and

displaying the covered target program image by the extended display device.

Optionally, the method further includes:

displaying the interaction interface on the local display device when a target gesture of the user is recognized.

A screen projection apparatus based on a wireless auxiliary stream device is provided, applicable to a wireless auxiliary stream device, where the wireless auxiliary stream device is connected to a terminal device and an extended display device, the terminal device is further connected to a local display device, and the apparatus includes:

a first interaction interface display module configured to display an interaction interface on the local display device when the terminal device is connected, where a plurality of triggerable function keys are disposed on the interaction interface, the plurality of function keys include program display keys corresponding to a plurality of programs and a screen display key, and the plurality of programs are programs currently running on the terminal device;

a target program image display module configured to obtain, when a user triggers a target program display key corresponding to a target program, a target program image of the target program displayed on the local display device, and display the target program image by the extended display device; and

a desktop image display module configured to display, by the extended display device, when the user triggers the screen display key, all images displayed on the local display device.

Optionally, the target program image display module includes:

an obtaining submodule for a display image of a local display device configured to obtain all the images displayed on the local display device;

an outer frame coordinate recognition submodule configured to recognize a plurality of outer frame coordinates of the target program on all the images;

a target program image copying submodule configured to copy the target program image from all the images according to the plurality of outer frame coordinates; and

a target program image display submodule configured to display the target program image by the extended display device.

Optionally, a size of an image that is capable of being displayed on the extended display device is the same as a size of an image that is capable of being displayed on the local display device, and a coordinate axis established by the extended display device is the same as a coordinate axis established by the local display device; and the target program image display submodule includes:

a first target program image display unit configured to display the target program image at a target position on the extended display device according to the plurality of outer frame coordinates.

Optionally, the plurality of programs include the target program and non-target programs located on an upper layer of the target program; and the target program image display module includes:

an overlapping part recognition submodule configured to recognize overlapping parts between the target program image and images of the non-target programs;

a covered target program image recognition submodule configured to cover an overlapping part on the target program image with black, and generate a covered target program image; and

a second target program image display submodule configured to display the covered target program image by the extended display device.

Optionally, the apparatus further includes:

a second interaction interface display module configured to display the interaction interface on the local display device when a target gesture of the user is recognized.

The present application has the following advantages:

In the present application, when a terminal device is connected, an interaction interface is displayed on a local display device. A plurality of triggerable function keys are disposed on the interaction interface, the plurality of function keys include program display keys corresponding to a plurality of programs and a screen display key, and the plurality of programs are programs currently running on the terminal device. When a user triggers a target program display key corresponding to a target program, a target program image of the target program displayed on the local display device is obtained, and the target program image is displayed by an extended display device. When the user triggers the screen display key, all images displayed on the local display device are displayed by the extended display device. Projected content is selected without projecting an entire screen of the local display device and all the programs, to protect the privacy of the user.

### BRIEF DESCRIPTION OF THE DRAWINGS

To describe the technical solutions in the present application more clearly, the accompanying drawings required to describe the present application are briefly described below. Apparently, the accompanying drawings described below are only some embodiments of the present application. A person of ordinary skill in the art may further obtain accompanying drawings of other embodiments based on these accompanying drawings without creative efforts.

FIG. 1 is a step flowchart of a screen projection method based on a wireless auxiliary stream device according to an embodiment of the present application.

FIG. 2 is another step flowchart of a screen projection method based on a wireless auxiliary stream device according to an embodiment of the present application.

FIG. 3 is a block structural diagram of a screen projection apparatus based on a wireless auxiliary stream device according to an embodiment of the present application.

### DETAILED DESCRIPTION

To make the above objectives, features and advantages of the present application clearer, specific implementations of the present application will be described below in detail with reference to the accompanying drawings and specific implementations. Apparently, the described embodiments are some rather than all of the embodiments of the present application. All other embodiments obtained by those of ordinary skill in the art based on the embodiments of the present application without creative efforts should fall within the protection scope of the present application.

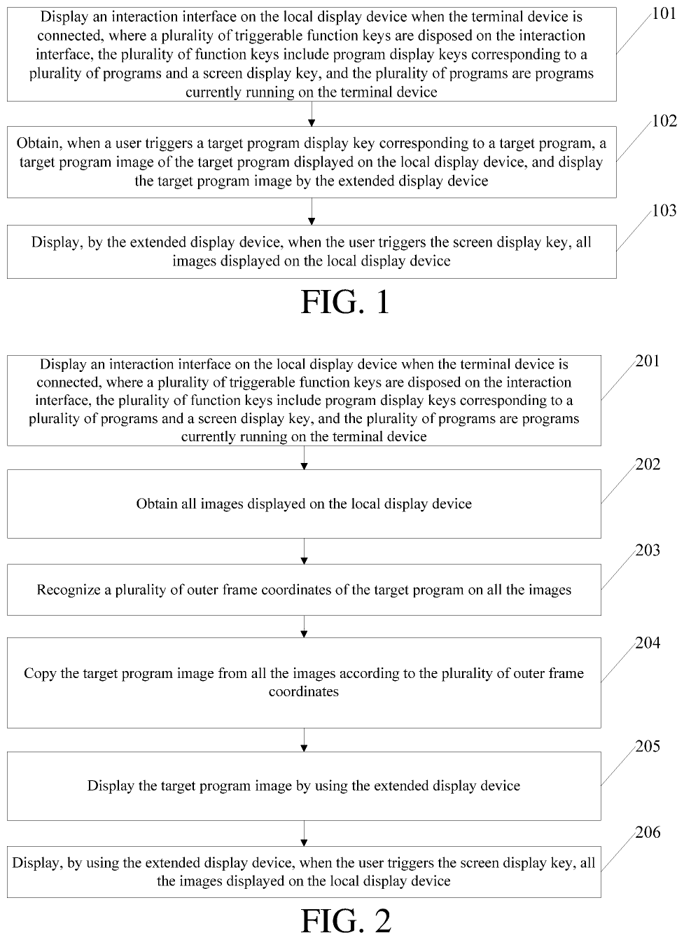

FIG. 1 is a step flowchart of a screen projection method based on a wireless auxiliary stream device according to an embodiment of the present application. The screen projection method based on a wireless auxiliary stream device is applicable to a wireless auxiliary stream device. Physical keys may be disposed on the wireless auxiliary stream device, or no physical keys may be disposed on the wireless auxiliary stream device. The wireless auxiliary stream device is connected to a terminal device and an extended display device, that is, the terminal device is connected to the extended display device by the wireless auxiliary stream device. For example, in one manner, the wireless auxiliary stream device is connected to the terminal device and the extended display device. In another manner, the wireless auxiliary stream device is connected to the terminal device and performs data transmission with the extended display device through a wireless network. Specifically, the wireless auxiliary stream device may be connected, that is, movably connected in a pluggable manner, to the terminal device and the extended display device by a universal serial bus. Data is exchanged between two wireless auxiliary stream devices in a wireless connection manner. Alternatively, the wireless auxiliary stream device may be connected to the terminal device by a universal serial bus and then directly exchange data with the extended display device in a wireless connection manner. The extended display device may be a display or a projector, or the extended display device may be any display device such as an intelligent conference tablet (for example, an interactive white board (IWB)), or the extended display device may be a host device or a conference host connected to a display device. The terminal device is further connected to a local display device. Specifically, the terminal device may be a computer host, and the local display device may be a display of the computer host, or the terminal device may be a notebook computer, and the local display device may be a display disposed on the notebook computer. The method may specifically include the following steps.

Step 101. Display an interaction interface on the local display device when the terminal device is connected, where a plurality of triggerable function keys are disposed on the interaction interface, the plurality of function keys include program display keys corresponding to a plurality of programs and a screen display key, and the plurality of programs are programs currently running on the terminal device.

The interaction interface is displayed on only the local display device or may be acquired for screen projection.

A user needs to install startup software on an auxiliary stream device when the wireless auxiliary stream device is used on the terminal device for the first time. Subsequently, a background program of the terminal device corresponding to the startup software may detect the auxiliary stream device, and an interaction interface is automatically enabled after it is detected that the auxiliary stream device is connected. When the wireless auxiliary stream device is connected to the terminal device, for example, the wireless auxiliary stream device is connected to the terminal device by a universal serial bus, the interaction interface is automatically enabled on a display device. A plurality of function keys are disposed on the interaction interface, the plurality of function keys include program display keys corresponding to a plurality of programs and a screen display key, and the plurality of function keys further include a selection key for screen projection quality and a function selection key for whether a screen is automatically projected when the wireless auxiliary stream device is inserted next time. The user may adjust display quality of a screen on the extended display device by the selection key for screen projection quality, and the adjustment of the display quality may be adjustment of resolution of a display screen. If a physical key is disposed on the wireless auxiliary stream device, pop-up of the interaction interface may be controlled through by the physical key.

In the related art, only one physical key on the wireless auxiliary stream device is not beneficial to expand the function of screen projection. For example, in a case of a good network condition, a user may choose higher screen projection quality. In a case of a poor network condition, the user may perform screen projection by giving a priority to fluency. However, in the present application, a plurality of function keys may be disposed on the interaction interface, to ensure the function expansion of screen projection.

In an embodiment of the present application, the method further includes:

displaying the interaction interface on the local display device when a target gesture of the user is recognized.

After the wireless auxiliary stream device is connected to the terminal device, the interaction interface may be displayed on the local display device by recognizing a target gesture of a user. For example, after the wireless auxiliary stream device is connected to the terminal device, the interaction interface is displayed on the local display device when it is recognized that a user shakes hands.

In addition, when the user performs screen projection by the interaction interface, the interaction interface exits, and a small icon is displayed on an edge of a screen of the local display device. The user may display the interaction interface by the small icon or may display the interaction interface by a target gesture.

Step 102. Obtain, when a user triggers a target program display key corresponding to a target program, a target program image of the target program displayed on the local display device, and display the target program image by the extended display device.

In an embodiment of the present application, the plurality of programs include the target program and non-target programs located on an upper layer of the target program; and step 102 includes:

Sub-step S11. Recognize overlapping parts between the target program image and images of the non-target programs.

Sub-step S12. Cover an overlapping part on the target program image with black, and generate a covered target program image.

Sub-step S13. Display the covered target program image by the extended display device.

During specific implementation, a stacking order of a window of a target program and windows of other non-target programs is obtained, the windows of the other non-target programs located on an upper layer of the target program are selected, and a union window P of the windows is obtained, that is, overlapping parts of a target program image and images of the non-target programs. The window of the target program is set to S, and a displayable region Q of the window of the target program is Q=S−P, that is, only the displayable region Q is reserved on a content region S of the target program, and the remaining part of S is covered with black by a black brush. Images obtained through the operations are encoded into an h264 code stream, and the h264 code stream is transmitted to the extended display device, to perform screen projection on only the target program but not display other programs.

Step 103. Display, by the extended display device, when the user triggers the screen display key, all images displayed on the local display device.

In the present application, when a terminal device is connected, an interaction interface is displayed on a local display device. A plurality of triggerable function keys are disposed on the interaction interface, the plurality of function keys include program display keys corresponding to a plurality of programs and a screen display key, and the plurality of programs are programs currently running on the terminal device. When a user triggers a target program display key corresponding to a target program, a target program image of the target program displayed on the local display device is obtained, and the target program image is displayed by an extended display device. When the user triggers the screen display key, all images displayed on the local display device are displayed by the extended display device. Projected content is selected without projecting an entire screen of the local display device and all the programs, to protect the privacy of the user.

FIG. 2 is another step flowchart of a screen projection method based on a wireless auxiliary stream device according to an embodiment of the present application. The screen projection method based on a wireless auxiliary stream device is applicable to a wireless auxiliary stream device. The wireless auxiliary stream device is connected to a terminal device and an extended display device, and the terminal device is further connected to a local display device. The screen projection method may specifically include the following steps.

Step 201. Display an interaction interface on the local display device when the terminal device is connected, where a plurality of triggerable function keys are disposed on the interaction interface, the plurality of function keys include program display keys corresponding to a plurality of programs and a screen display key, and the plurality of programs are programs currently running on the terminal device.

Step 202. Obtain all images displayed on the local display device.

Step 203. Recognize a plurality of outer frame coordinates of the target program on all the images.

The plurality of outer frame coordinates (distances of the top, bottom, left, and right of an outer frame relative to an origin of a screen) of the target program are recognized.

Step 204. Copy the target program image from all the images according to the plurality of outer frame coordinates.

Step 205. Display the target program image by the extended display device.

Step 206. Display, when the user triggers the screen display key, all the images displayed on the local display device by the extended display device.

In an embodiment of the present application, a size of an image that is capable of being displayed on the extended display device is the same as a size of an image that is capable of being displayed on the local display device, and a coordinate axis established by the extended display device is the same as a coordinate axis established by the local display device; and step 206 includes:

displaying the target program image at a target position on the extended display device according to the plurality of outer frame coordinates.

In the present application, all images displayed on the local display device are obtained, a plurality of outer frame coordinates of the target program on all the images are recognized, a target program image is copied from all the images according to the plurality of outer frame coordinates, and the target program image is displayed by the extended display device. When the user triggers the screen display key, all the images displayed on the local display device are displayed by the extended display device, to ensure accurate recognition of the target program image and protect the privacy of the user.

It should be noted that for the sake of simple description, the method embodiments are all described as a series of action combinations. However, a person skilled in the art should know that the embodiments of the present application are not limited by the described action sequence because some steps may be performed in other sequences or simultaneously according to the embodiments of the present application. Next, a person skilled in the art should learn that the embodiments described in this specification all belong to preferred embodiments and the involved actions are not necessary for the present application.

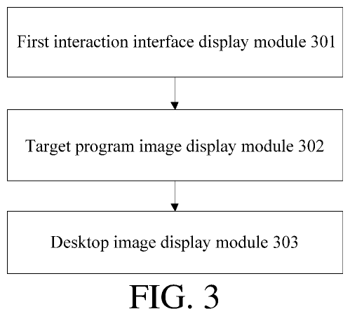

FIG. 3 is a block structural diagram of a screen projection apparatus based on a wireless auxiliary stream device according to an embodiment of the present application. The screen projection apparatus based on a wireless auxiliary stream device is applicable to a wireless auxiliary stream device. The wireless auxiliary stream device is connected to a terminal device and an extended display device, and the terminal device is further connected to a local display device. The screen projection apparatus may specifically include the following modules:

a first interaction interface display module 301 configured to display an interaction interface on the local display device when the terminal device is connected, where a plurality of triggerable function keys are disposed on the interaction interface, the plurality of function keys include program display keys corresponding to a plurality of programs and a screen display key, and the plurality of programs are programs currently running on the terminal device;

a target program image display module 302 configured to obtain, when a user triggers a target program display key corresponding to a target program, a target program image of the target program displayed on the local display device, and display the target program image by the extended display device; and

a desktop image display module 303 configured to display, by the extended display device, when the user triggers the screen display key, all images displayed on the local display device.

In an embodiment of the present application, the target program image display module 302 includes:

an obtaining submodule for a display image of a local display device configured to obtain all the images displayed on the local display device;

an outer frame coordinate recognition submodule configured to recognize a plurality of outer frame coordinates of the target program on all the images;

a target program image copying submodule configured to copy the target program image from all the images according to the plurality of outer frame coordinates; and

a target program image display submodule configured to display the target program image by the extended display device.

In an embodiment of the present application, a size of an image that is capable of being displayed on the extended display device is the same as a size of an image that is capable of being displayed on the local display device, and a coordinate axis established by the extended display device is the same as a coordinate axis established by the local display device; and the target program image display submodule includes:

a first target program image display unit configured to display the target program image at a target position on the extended display device according to the plurality of outer frame coordinates.

In an embodiment of the present application, the plurality of programs include the target program and non-target programs located on an upper layer of the target program; and the target program image display module 302 includes:

an overlapping part recognition submodule configured to recognize overlapping parts between the target program image and images of the non-target programs;

a covered target program image recognition submodule configured to cover an overlapping part on the target program image with black, and generate a covered target program image; and

a second target program image display submodule configured to display the covered target program image by the extended display device.

In an embodiment of the present application, the apparatus further includes:

a second interaction interface display module configured to display the interaction interface on the local display device when a target gesture of the user is recognized.

In the present application, when a terminal device is connected, an interaction interface is displayed on a local display device. A plurality of triggerable function keys are disposed on the interaction interface, the plurality of function keys include program display keys corresponding to a plurality of programs and a screen display key, and the plurality of programs are programs currently running on the terminal device. When a user triggers a target program display key corresponding to a target program, a target program image of the target program displayed on the local display device is obtained, and the target program image is displayed by an extended display device. When the user triggers the screen display key, all images displayed on the local display device are displayed by the extended display device. Projected content is selected without projecting an entire screen of the local display device and all the programs, to protect the privacy of the user.

In another embodiment, the screen projection apparatus based on a wireless auxiliary stream device includes: a processor configured to execute the program modules stored in a memory, where the program modules include: the first interaction interface display module 301, the target program image display module 302, the desktop image display module 303, the second interaction interface display module, the obtaining submodule for a display image of a local display device, the outer frame coordinate recognition submodule, the target program image copying submodule, the target program image display submodule, the first target program image display unit, the overlapping part recognition submodule, the covered target program image recognition submodule, and the second target program image display submodule.

The apparatus embodiments are substantially similar to the method embodiments and therefore are only briefly described, and reference may be made to the method embodiments for associated part.

An embodiment of the present application further provides an electronic device, including a processor, a memory, and a computer program stored on the memory and executable on the processor, where the computer program, when being executed by the processor, implements the steps of the screen projection method based on a wireless auxiliary stream device.

An embodiment of the present application further provides a computer-readable storage medium, storing a computer program, where the computer program, when being executed by a processor, implements the steps of the screen projection method based on a wireless auxiliary stream device.

The embodiments of this specification are described in a progressive manner, and each embodiment focuses on differences from other embodiments. The same or similar parts between the embodiments may refer to each other.

A person skilled in the art should understand that the embodiments of the present application may be provided as a method, an apparatus, or a computer program product. Therefore, the embodiments of the present application may use a form of hardware only embodiments, software only embodiments, or embodiments with a combination of software and hardware. Moreover, the embodiments of the present application may be in a form of a computer program product that is implemented on one or more computer-usable storage media (including but not limited to a magnetic disk memory, a CD-ROM, an optical memory, and the like) that include computer-usable program code.

The embodiments of the present application are described with reference to the flowcharts and/or block diagrams of the method, the terminal device (system), and the computer program product according to the embodiments of the present application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, such that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, such that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, such that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some preferred embodiments of the present application have been described, those skilled in the art can make changes and modifications to these embodiments once they learn the basic inventive concept. Therefore, the appended claims are intended to be interpreted as including the preferred embodiments and all changes and modifications falling within the scope the embodiments of the present application.

Finally, it should be noted that relational terms in this specification such as first and second are only used to distinguish one entity or operation from another entity or operation without necessarily requiring or implying any actual such relationship or order between such entities or operations. In addition, the terms “including”, “comprising”, or any other variants thereof are intended to cover non-exclusive inclusion, such that a process, method, article, or device including a series of elements includes not only those elements but also other elements not explicitly listed, or elements inherent to such a process, method, article, or terminal device. Without more restrictions, the elements defined by the sentence “including a . . . ” do not exclude the existence of other identical elements in a process, method, article, or terminal device including the elements.

The screen projection method and apparatus based on a wireless auxiliary stream device provided in the present application are described above in detail. In this specification, several examples are used for illustration of the principles and implementations of the present application. The description of the foregoing examples is used to help illustrate the method of the present application and the core principles thereof. In addition, a person of ordinary skill in the art can make various modifications in terms of specific implementations and scope of application in accordance with the teachings of the present application. Based on the foregoing, the content in this specification should not be understood as a limitation on the present application.

1. A screen projection method based on a wireless auxiliary stream device, applicable to a wireless auxiliary stream device, wherein the wireless auxiliary stream device is connected to a terminal device and an extended display device, the terminal device is further connected to a local display device, and the method comprises:
displaying an interaction interface on the local display device when the terminal device is connected, wherein a plurality of triggerable function keys are disposed on the interaction interface, the plurality of function keys comprise program display keys corresponding to a plurality of programs and a screen display key, and the plurality of programs are programs currently running on the terminal device;
obtaining, when a user triggers a target program display key corresponding to a target program, a target program image of the target program displayed on the local display device, and displaying the target program image by the extended display device; and
displaying, by the extended display device, when the user triggers the screen display key, all images displayed on the local display device.

2. The screen projection method based on a wireless auxiliary stream device according to claim 1, wherein the obtaining a target program image of the target program displayed on the local display device, and displaying the target program image by the extended display device comprises:
obtaining all the images displayed on the local display device;
recognizing a plurality of outer frame coordinates of the target program on all the images;
copying the target program image from all the images according to the plurality of outer frame coordinates; and
displaying the target program image by the extended display device.

3. The screen projection method based on a wireless auxiliary stream device according to claim 2, wherein a size of an image that is capable of being displayed on the extended display device is the same as a size of an image that is capable of being displayed on the local display device, and a coordinate axis established by the extended display device is the same as a coordinate axis established by the local display device; and the displaying the target program image by the extended display device comprises:
displaying the target program image at a target position on the extended display device according to the plurality of outer frame coordinates.

4. The screen projection method based on a wireless auxiliary stream device according to claim 1, wherein the plurality of programs comprise the target program and non-target programs located on an upper layer of the target program; and the obtaining a target program image of the target program displayed on the local display device, and displaying the target program image by the extended display device comprises:
recognizing overlapping parts between the target program image and images of the non-target programs;
covering an overlapping part on the target program image with black, and generating a covered target program image; and
displaying the covered target program image by the extended display device.

5. The screen projection method based on a wireless auxiliary stream device according to claim 1, further comprising:
displaying the interaction interface on the local display device when a target gesture of the user is recognized.

6. A screen projection apparatus based on a wireless auxiliary stream device, applicable to a wireless auxiliary stream device, wherein the wireless auxiliary stream device is connected to a terminal device and an extended display device, the terminal device is further connected to a local display device, and the apparatus comprises:
a first interaction interface display module configured to display an interaction interface on the local display device when the terminal device is connected, wherein a plurality of triggerable function keys are disposed on the interaction interface, the plurality of function keys comprise program display keys corresponding to a plurality of programs and a screen display key, and the plurality of programs are programs currently running on the terminal device;
a target program image display module configured to obtain, when a user triggers a target program display key corresponding to a target program, a target program image of the target program displayed on the local display device, and display the target program image by the extended display device; and
a desktop image display module configured to display, by the extended display device, when the user triggers the screen display key, all images displayed on the local display device.

7. The screen projection apparatus based on a wireless auxiliary stream device according to claim 6, wherein the target program image display module comprises:
an obtaining submodule for a display image of a local display device configured to obtain all the images displayed on the local display device;
an outer frame coordinate recognition submodule configured to recognize a plurality of outer frame coordinates of the target program on all the images;
a target program image copying submodule configured to copy the target program image from all the images according to the plurality of outer frame coordinates; and
a target program image display submodule configured to display the target program image by the extended display device.

8. The screen projection apparatus based on a wireless auxiliary stream device according to claim 7, wherein a size of an image that is capable of being displayed on the extended display device is the same as a size of an image that is capable of being displayed on the local display device, and a coordinate axis established by the extended display device is the same as a coordinate axis established by the local display device; and the target program image display submodule comprises:
a first target program image display unit configured to display the target program image at a target position on the extended display device according to the plurality of outer frame coordinates.

9. The screen projection apparatus based on a wireless auxiliary stream device according to claim 6, wherein the plurality of programs comprise the target program and non-target programs located on an upper layer of the target program; and the target program image display module comprises:
an overlapping part recognition submodule configured to recognize overlapping parts between the target program image and images of the non-target programs;
a covered target program image recognition submodule configured to cover an overlapping part on the target program image with black, and generate a covered target program image; and
a second target program image display submodule configured to display the covered target program image by the extended display device.

10. The screen projection apparatus based on a wireless auxiliary stream device according to claim 6, further comprising:
a second interaction interface display module configured to display the interaction interface on the local display device when a target gesture of the user is recognized.
